(19) United States
(12) Patent Application Publication
(10) Pub. No.: US 2007/0269348 A1
(43) Pub. Date: Nov. 22, 2007

(54) ENHANCED DROPLET FLOW CYTOMETER SYSTEM AND METHOD

(75) Inventors: Ger J. van den Engh, Seattle, WA (US); Timothy W. Petersen, Seattle, WA (US); Jarred E. Swalwell, Shoreline, WA (US)

Correspondence Address: DAVIS WRIGHT TREMAINE, LLP, 1201 Third Avenue, Suite 2200, SEATTLE, WA, 98101-3045, US

(73) Assignee: Cytopeia Incorporated, Seattle, WA (US)

(21) Appl. No.: 11/419,465

(22) Filed: May 19, 2006

(51) Int. Cl. B01L 3/02

(52) U.S. Cl. 422/100

(57) ABSTRACT

An enhanced droplet flow cytometer system and method allows for improvement in performance, maintainability, and adaptability to operational conditions encountered. The enhanced system uses an oscillator positioned and configured to impart vibrational energy transverse to fluid flow. In some implementations, an oscillator provides a radial pressure field to the sheath fluid to avoid exciting resonances in the system. Implementations use removable recessed nozzles to aid in cleaning and replacement without imparting appreciable turbulence to fluid flow during operation.

### BACKGROUND OF THE INVENTION

1. Field of the Invention

The present invention is related to droplet flow cytometers.

2. Description of the Related Art

In general droplet flow cytometer systems are used for the analysis and sorting of substances contained within separate droplets. Such systems depend upon formation of droplets of consistent size and spacing from a fluid stream soon after its exit from a nozzle orifice.

Droplet flow cytometer systems position small amounts of a sample of interest within individual droplets of a sheath fluid. Consistency of droplet formation has been achieved to a certain degree through the use of conventional oscillators that emit a predominant frequency to typically vibrate a nozzle.

Unfortunately, conventional approaches have not been able to overcome certain shortcomings. Conventional rates of droplet formation have been limited in practical terms to operational frequency maximums that are far below that of existing requirements. Conventional oscillator arrangements also have inherent resonance characteristics that further limit frequency selection for the oscillator and related droplet formation rate.

For instance, some resonances are highly sensitive to drift in driving frequency thereby causing drastic change in oscillator response and disrupting droplet formation. Variation in droplet formation can have disastrous consequences for the efficiency and the purity of fractions sorted by these systems. As known, stability of the droplet formation is dependent upon unique combinations of formation rate, fluid velocity and nozzle size. Consequently, limitations in selection of operational frequency can directly affect stability of droplet formation.

Furthermore, conventional approaches require relatively high power levels and voltage levels (such as tens of volts) that also tend to limit application. The conventional approaches have sought to increase power levels to meet higher frequency requirements, which further adds difficulties.

A need to adjust operational parameters, such as sample output velocity, to adapt to actual conditions encountered in processing can be highly desirable. Unfortunately, as suggested by the discussion above, adjustment of conventional systems to adapt to less than ideal operational conditions tends to reduce, rather than improve, operational performance.

### BRIEF DESCRIPTION OF THE SEVERAL VIEWS OF THE DRAWING(S)

FIG. 1 is a schematic diagram of an enhanced droplet flow cytometer system.

FIG. 2 is a perspective view of an implementation of a nozzle assembly of the enhanced droplet flow cytometer system of FIG. 1.

FIG. 3 is an elevational sectional view of the nozzle assembly taken along the 3-3 line of FIG. 2.

FIG. 4 is a top sectional view of the nozzle assembly taken along the 4-4 line of FIG. 2.

FIG. 5 is a top sectional view of the nozzle assembly taken along the 5-5 line of FIG. 2.

FIG. 6 is an enlarged fragmented view of the nozzle assembly shown in FIG. 3.

FIG. 7 is an exploded sectional view of the nozzle assembly shown in FIG. 6.

FIG. 8 is an elevational sectional view of an implementation of a nozzle having linearly varying cross-sectional area.

FIG. 9 is a graph of nozzle radius squared versus nozzle position of the nozzle of FIG. 8.

FIG. 10 is a top view of the transverse oscillator of FIG. 7 showing electrode detail.

FIG. 11 is an elevational sectional view of the transverse oscillator taken along the 11-11 line of FIG. 10.

FIG. 12 is a performance graph of a conventional droplet flow cytometer system.

FIG. 13 is a performance graph of an implementation of the enhanced droplet flow cytometer system.

### DETAILED DESCRIPTION OF THE INVENTION

As discussed herein, an enhanced droplet flow cytometer system and method allows for improvement in performance, maintainability, and adaptability to operational conditions encountered. The enhanced system uses an oscillator positioned and configured to impart vibrational energy transverse to fluid flow. In some implementations, an oscillator provides a radial pressure field to the sheath fluid to avoid exciting resonances in the system.

Radial pressure can be introduced by a shaped oscillator positioned about the sheath fluid container (such as a cylindrically shaped oscillator about a tubular sheath fluid container) to more directly couple oscillations with sheath fluid at a location up stream from a continuously converging nozzle. Vibrational energy imparted transverse to fluid flow can be better isolated from introducing structural resonances, such as longitudinal resonances, either upstream or downstream from the oscillator.

Consequences can include reduced energy requirements and reduced sensitivity to fluctuations or other sorts of changes in operational frequency thereby allowing for greater adaptability with greater performance over a broader range of frequencies including sizably higher operational frequencies and at sizably lower power requirements. The enhanced system further includes a removable nozzle design that allows for cleaning of the system while introducing little if any performance robbing turbulence that may otherwise be introduced by a removable nozzle.

Implementations of the enhanced system further include a nozzle shaped with a continuous convergence to further encourage and maintain laminar fluid flow. To maintain laminar flow and to effectively focus the sample hydrodynamically, in some implementations nozzle shape is varied to achieve a constant fluid acceleration. The enhanced system also can vary location at which a substance is introduced while still maintaining optimal, laminar conditions.

Implementations of the enhanced system may be called upon to produce and analyze droplets at rates involving thousands of biological cells or other biological entities a second. As part of the enhanced system, for each cell that passes through the focus of a laser beam, electronics classify its scattering and fluorescent characteristics and decide whether the cell meets specified criteria. If a cell of interest meets an investigator's specifications, the cell is flagged for sorting. To sort the selected cell, the electronics must wait for a precise period of time, and then charge a fluid stream. The charging of the stream will cause a single droplet to retain electrical charge and be deflected from the stream. If a sorter is properly configured, the sorted droplet will contain the cell of interest. If the sorter is not properly configured or is unstable with respect to time, the sorter might charge a droplet that is either empty or contains a cell that does not meet the selection criteria. Thus, predictable formation of droplets is a requirement for dependable sorting performed by implementations of the enhanced system.

In order to predictably produce droplets, implementations use a traverse oscillator coupled to nozzle piping and driven at a desired frequency. The oscillatory vibrational forces of the transverse oscillator imprints a small perturbation on the surface of a fluid stream. Surface tension resistively interacts with these perturbations, causing them to quickly grow until they are larger than stream dimensions at which point the stream separates into discrete droplets.

The physical mechanisms that cause the stream to separate are well understood. To optimize the stability of the droplet formation, one can make use of these physical laws to ensure that the droplet separation point is insensitive to changes in the physical environment such as temperature and barometric pressure. As a result, for a given nozzle opening and sort speed, there is a single frequency that gives optimal performance and stability. Unfortunately, many conventional nozzle assemblies are dominated by mechanical resonances that limit the useful range of the droplet formation to a few available frequencies. Moreover, these conventional droplet formations systems will have large changes in the efficiency of creating perturbations with small changes in the frequency further compromising their performance. The enhanced system overcomes these limitations through aspects such as having a relatively flat frequency response in that perturbation levels remain relatively appreciable over a wide range of frequencies. Other aspects include having good coupling of oscillation generation to the fluid stream for substantially all frequencies between near zero to 10 kHz and from near 10 kHz to at least 120 kHz.

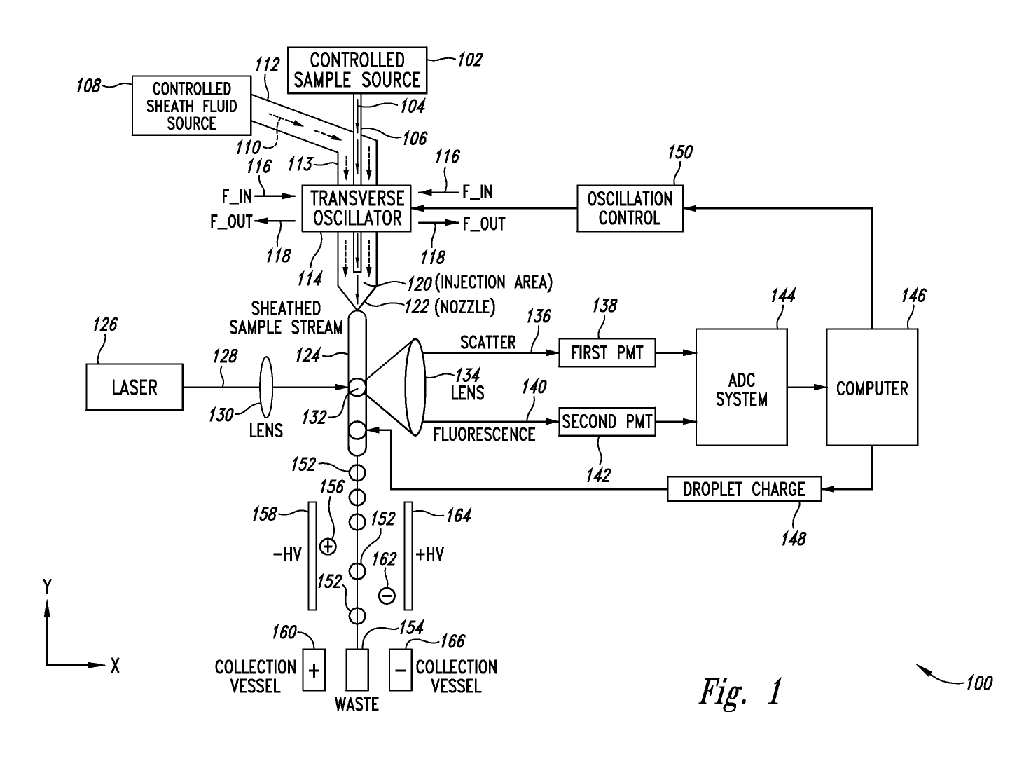

An implementation of an enhanced droplet flow cytometer system 100 is shown in FIG. 1 as having a controlled sample source 102 containing sample fluid 104 and fluidly coupled to sample tubing 106. The enhanced system 100 further contains a controlled sheath fluid source 108 containing sheath fluid 110 and fluidly coupled to sheath tubing 112. As shown, the sheath tubing 112 couples to nozzle tubing 113 and the sample tubing 106 is inserted into nozzle tubing 113 and extends down a distance positioned in the middle of the nozzle tubing to keep the sample fluid 104 separate from the sheath fluid 110 while the sample fluid remains inside the sample tubing.

A transverse oscillator 114 is externally coupled to the nozzle tubing 113 to impart inward vibrational force F_IN 116 and/or outward vibrational force F_OUT 118 to the nozzle tubing substantially transverse to direction of flow of the sheath fluid 110 contained within the nozzle tubing and the sample fluid 104 contained within the sample tubing inside the nozzle tubing.

The enhanced system 100 further contains an injection point 120 where the sample fluid 104 leaves the sample tubing 106 and enters the sheath fluid 110. As discussed further below, the enhanced system 100 is configured to maintain laminar flow of the sample fluid 104 and the sheath fluid 110 such that minimal mixing occurs between the sample fluid and the sheath fluid except primarily for mixing by diffusion. Since mixing by diffusion typically takes a relatively long period of time, mixing of the sample fluid 104 with the sheath fluid 110 is kept to a relative minimum. Rate at which the sample fluid 104 is injected into the sheath fluid 110 can be adjusted by changing position of the injection point 120 by sliding the sample tubing 106 further into or further out of the nozzle tubing 113.

The sample fluid 104 and the sheath fluid 110 exit the nozzle tubing 113 through a nozzle 122 of the enhanced system 100 as a sheathed sample stream 124 in which the sample fluid substantially flows as a stream enclosed by the sheath fluid substantially flowing is a stream separate from the sample fluid. The enhanced system 100 has a laser 126 positioned to direct laser light 128 through a first lens 130 to interact with a portion 132 of the sheathed sample stream 124. The laser light 128 is tightly focused to increase the size of a scatter portion 136 and a fluorescence portion 138 of the laser light. The center of the focused beam of the laser light 128 has a very predictable distribution, but near the edges, variations in the intensity may make cells appear to be smaller or less fluorescent than they actually are. For these reasons, one would like to localize the cells at the core of the fluid stream rather than letting them distribute at random. The localization is achieved by carefully injecting and maintaining the sample fluid 104 containing the cells centrally in relation to the sheathed fluid 110 to be equally surrounded by the sheathed fluid by taking precautions to keep flow of the sample fluid 104 and the sheathed fluid 110 laminar rather than turbulent. In laminar flow, the sample fluid 104 containing the cells will mix with the sheath fluid 110 only via diffusion, which is a very slow process for something the size of a cell.

After interaction, the laser light 128 is received by a second lens 134, which directs the scatter portion 136 of the laser light to a first photomultiplier tube 138 and the fluorescence portion 138 of the laser light to a second photomultiplier tube 142. The first photomultiplier tube 138 and the second photomultiplier tube 142 each send analog signals to an analog-to-digital converter system 144 based upon the scatter portion 136 and the fluorescent portion 138, respectively received. The analog-to-digital converter system 144 in turn updates a computer 146 of the enhanced system 100.

The enhanced system 100 includes a droplet charge 148 that imparts various amounts of electrical charge to the sheathed sample stream 124 based upon control by the computer 146. An oscillation control 150 of the enhanced system 100 is directed by the computer 146 to control frequency and vibrational amplitude produced by the transverse oscillator 114.

After a small distance of travel from exiting the nozzle 122, droplets 152 are formed from the sheathed sample stream 124 according to perturbations introduced into the sheathed sample stream by the inward vibrational forces F_IN 116 and/or the outward vibrational forces F_OUT 118 from the transverse oscillator 114. In implementations, with each voltage cycle applied to the traverse oscillator 114, a perturbation is imparted to the sheathed sample stream 124 resulting in a formation of a droplet 152. The droplets 152 are then separated and collected by the enhanced system 100 according to amount or lack of charge previously imparted to a respective portion of the sheathed sample stream 124 by the droplet charge 148. If a particular one of the droplets 152 has little or no charge, it will pass into a waste vessel 154. A negatively charged high voltage plate 158 and a positively charged high voltage plate 164 set up a field that diverts a positively charged droplet 156 into a collection vessel 160 and a negatively charged droplet 162 into another collection vessel 166 of the enhanced system 100.

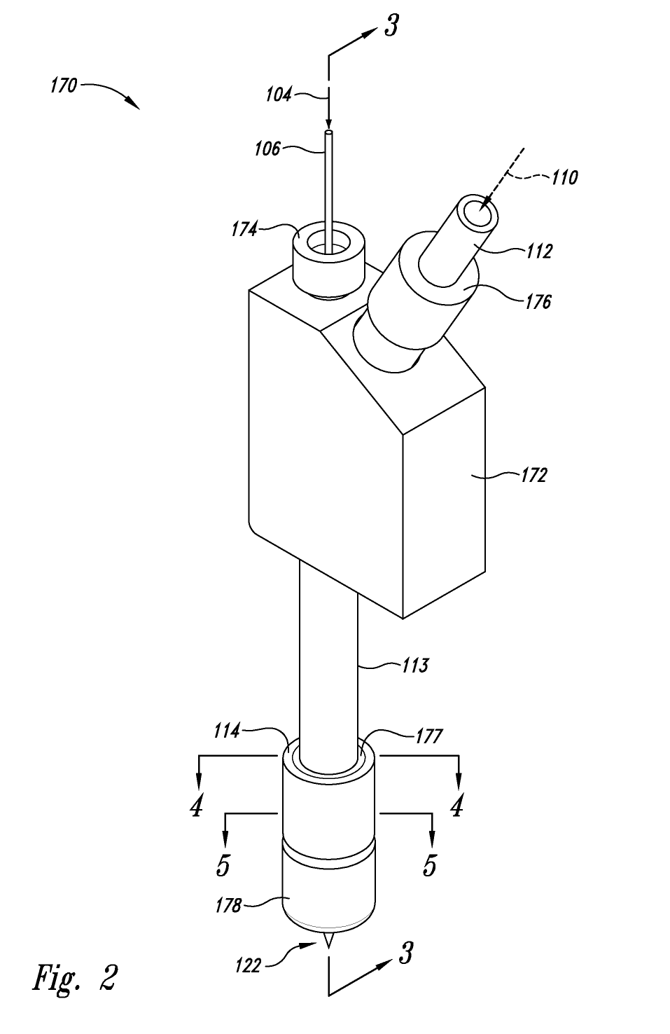

Further detail is shown of an implementation of a nozzle assembly portion 170 of the enhanced system 100 in FIG. 2 to include a manifold 172 receiving a first nut 174 to retain the sample tubing 106 and a second nut 176 to retain the sheath tubing 112. The manifold 172 generally contains plumbing for the sample fluid 104 and the sheath fluid 110 to be properly sealed and engaged with each other in a laminar manner. The nozzle assembly portion 170 is also generally configured to maintain laminar engagement of the sample fluid 104 with the sheath fluid 110, to hydrodynamically focus the sample fluid and the sheath fluid through the nozzle 122 to exit as the sheathed sample stream 124 and to imprint a substantially consistent and regular perturbation by the transverse oscillator 114 on the surface of the sheathed sample stream for consistent and predictable droplet formation. In one implementation, focusing by the nozzle 122 accelerates the sample fluid 104 and the sheath fluid 110 from 0.3 mm/sec to roughly 20 m/s as it leaves the nozzle without interrupting the laminar flow.

To promote laminar flow, care is used to avoid any sudden changes in the size or shape of tubing involved with the enhanced droplet flow cytometer including the nozzle assembly portion 170. For instance, as discussed further below, the inner diameter of the nozzle tubing 113 is machined to match the inner diameter of the nozzle 122 at their intersection point where they join together. Further attention is paid to the shape of the nozzle 122 so that acceleration of the sample fluid 104 and the sheath fluid 110 is done in a manner without abrupt changes in the radius of the nozzle 122 being encountered by the sample fluid and the sheath fluid.

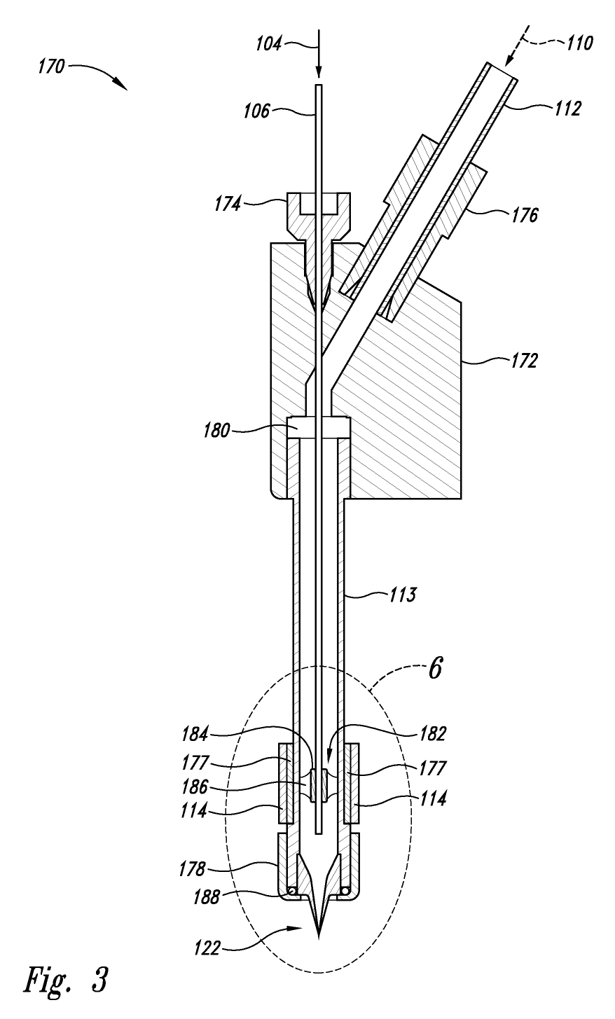

The transverse oscillator 114 is depicted as substantially cylindrical in form enclosing a portion of the nozzle tubing 113. A spacer 177 is used to securely couple the cylindrical implementation of the transverse oscillator 114 to the nozzle tubing 113 in the depicted implementation due to required sizing of the transverse oscillator to position the transverse oscillator on to the nozzle tubing. Better shown in FIG. 3, a nut 178 secures the nozzle 122 to the nozzle tubing 113. A version of this implementation can be made on the order of approximately four inches long. The transverse oscillator 114 as a piezoelectric ring operating in a radial mode about the nozzle tubing 113, alternately compresses and releases the outer surface of the nozzle tubing. By doing so, the sample fluid 104 and the sheath fluid 110 in the nozzle 122 is subtly perturbed to push a bit more and then a bit less of the sample fluid and the sheath fluid out of the nozzle. These perturbations set up regular oscillations on the surface of the sheathed sample stream 124. Although these oscillations can be exceedingly small (˜1 nm), the oscillations can quickly grow to cleave the sheathed sample stream 124 into the droplets 152, 158, and 162. The regularity and consistency of droplet formation is a requirement for predictable efficient sorting for droplet flow cytometers.

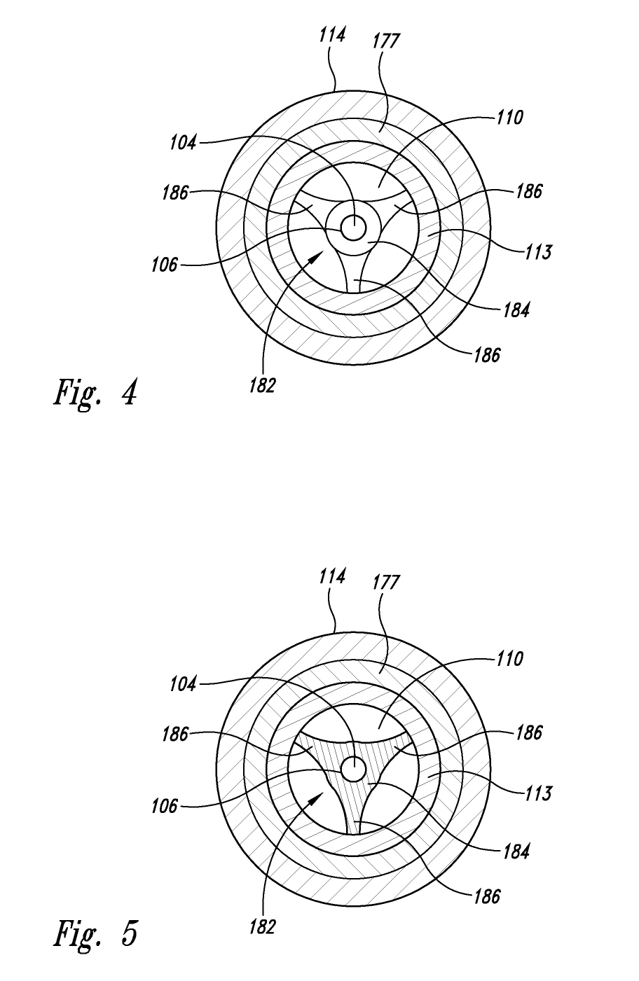

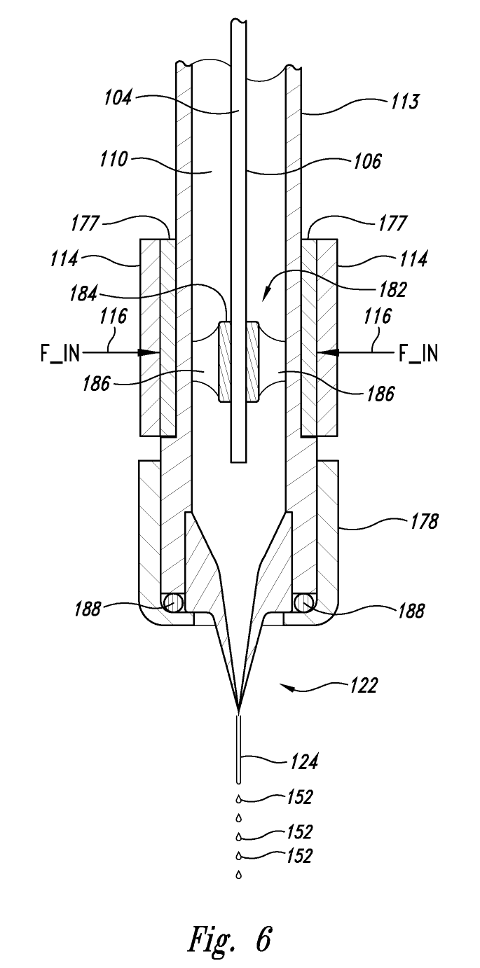

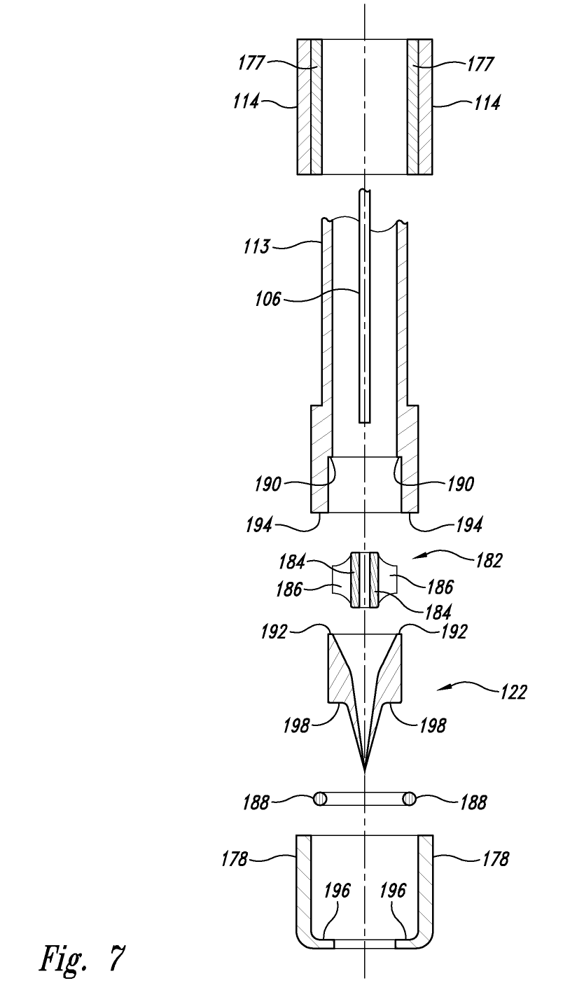

As shown in FIG. 3, an interface portion 180 is used within the manifold 172 to sealably couple the sample tubing 106 and the sheathed tubing 112 with the nozzle tubing 113. A guide 182 is located near the downstream end of the sample tubing 106 to centrally position the sample tubing within the nozzle tubing 113. The guide 182, better shown in FIG. 4 and FIG. 5, has a collar 184 to couple with the sample tubing 106 and positioning members 186 to centrally locate the sample tubing within the nozzle tubing 113. An O-ring 188, better shown in FIG. 6 and FIG. 7, is used to help seal the nozzle 122, the nozzle tubing 113, and the nut 178 as assembled together.

In the depicted implementation, the nozzle tubing 113 has recesses 190 (shown in FIG. 7) to receive top corner edges 192 of the nozzle 122 thereby allowing coupling of the nozzle with the nozzle tubing while maintaining substantially the same inner diameter of the nozzle tubing at the recesses as the inner diameter of the nozzle at the edges. Substantially the same inner diameter of the nozzle tubing 113 and the nozzle 122 where the two meet helps to maintain laminar flow of the sample fluid 104 and the sheath fluid 110 as they flow from the nozzle tubing into the nozzle. On the other hand, the depicted implementation allows for ready disassembly of the nozzle 122 from the nozzle tubing 113 for cleaning and/or parts replacement. The nut 178 has a surface 196 and the nozzle 122 has a surface 198 whereby the O-ring 188 is positioned therebetween for the above mentioned sealing of the nut, the nozzle, and the nozzle tubing 113 when assembled together.

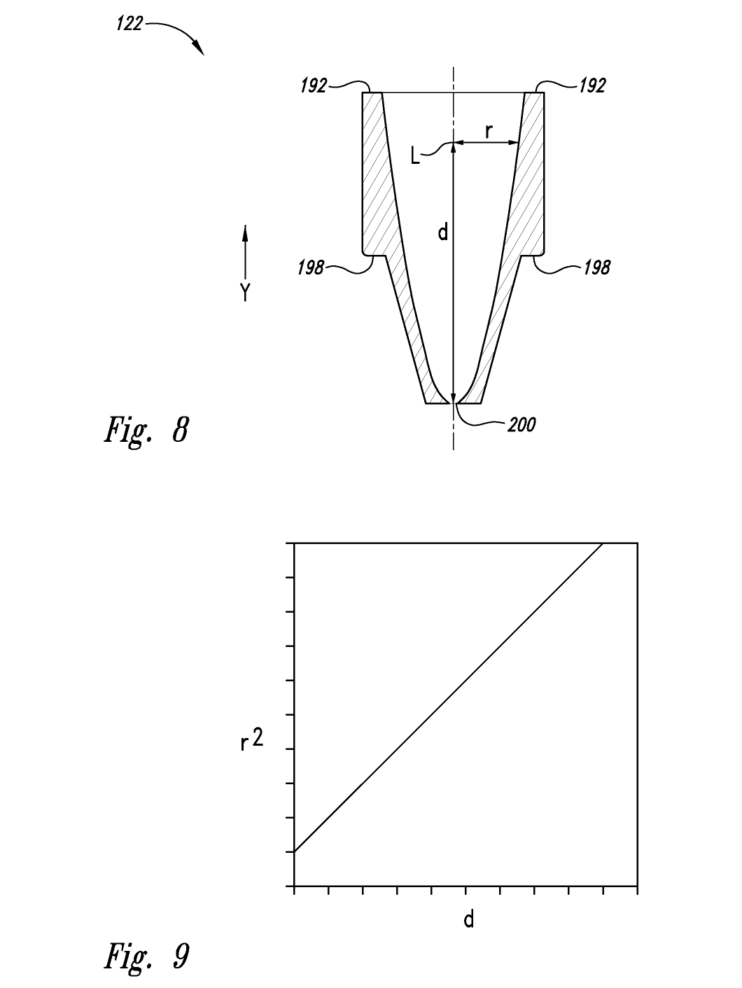

A further enhanced implementation of the nozzle 122 is shown in FIG. 8 in which the radius, r, of the nozzle at any location, L, along the dimension, Y, is related to the distance, d, along the dimension, Y, from the nozzle's orifice 200 to the location, L, such that the square of the radius, r, is substantially proportional to the distance, d, as exemplarily depicted in FIG. 9. As a consequence, the cross-sectional area of the nozzle 122 taken tangential to the dimension, Y, decreases in a linear fashion as the location, L, approaches the nozzle orifice 200. As a further consequence, the sample fluid 104 and the sheath fluid 110 have substantially constant acceleration through the nozzle 122 as they approach the nozzle orifice 200 thereby helping to maintain laminar flow of the sample fluid and the sheath fluid.

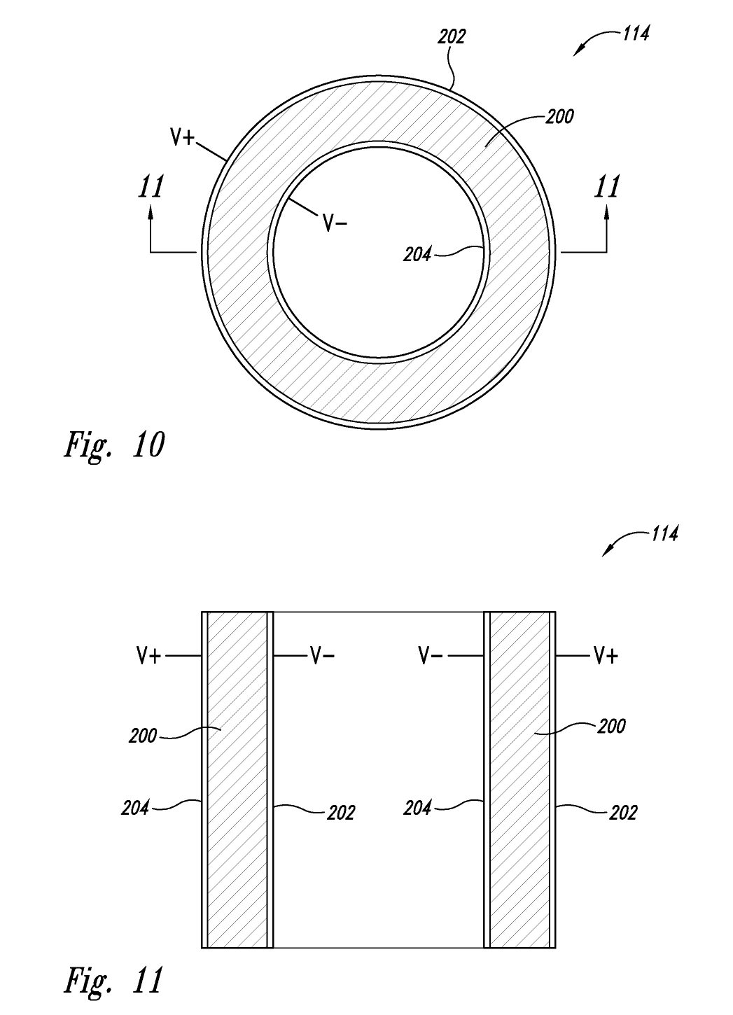

Further detail of the depicted implementation of the transverse oscillator 114 is shown in FIG. 10 and FIG. 11 as having an oscillator material (such as a ceramic piezoelectric material) between a thin outer layer 202 and a thin inner layer 204 of electrode material. Charge of a first polarity (depicted as positive) is applied to the outer layer 202 and charge of a second polarity (depicted as negative) opposite the first polarity is applied to the inner layer 204 to energize the oscillator material to oscillate. In a ceramic piezoelectric version of this implementation, the transverse oscillator 114 is driven by +/−20 Volts. The version has a thickness of the oscillator material 200 between the outer layer 202 and the inner layer 204 of approximately 1 mm (1×10**−3 meters). For each voltage cycle the thickness of the oscillator material 200 changes by 80 nm (8×10**−8 meters). The height of this version is approximately 10 mm tall.

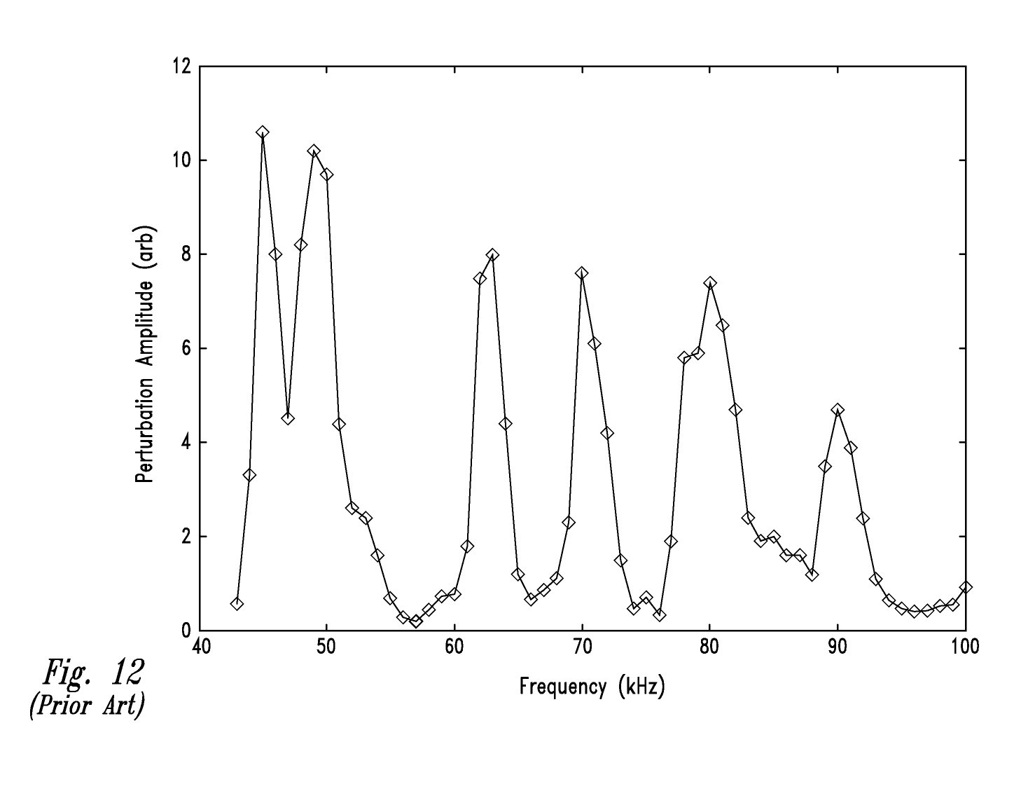

A graph of performance of a conventional droplet flow cytometer system is shown in FIG. 12 to have a sporadic perturbation amplitude through oscillation frequencies of a conventional oscillator above 40 kHz making use of such a conventional system generally impractical for these frequencies. As stated above, efficiency of coupling of the driving oscillations of a conventional oscillator to nozzle vibrations is dominated by mechanical resonances in the conventional nozzle. These resonances can be the result of coupling occurring between oscillator vibrations to longitudinal modes of the conventional nozzle tubing.

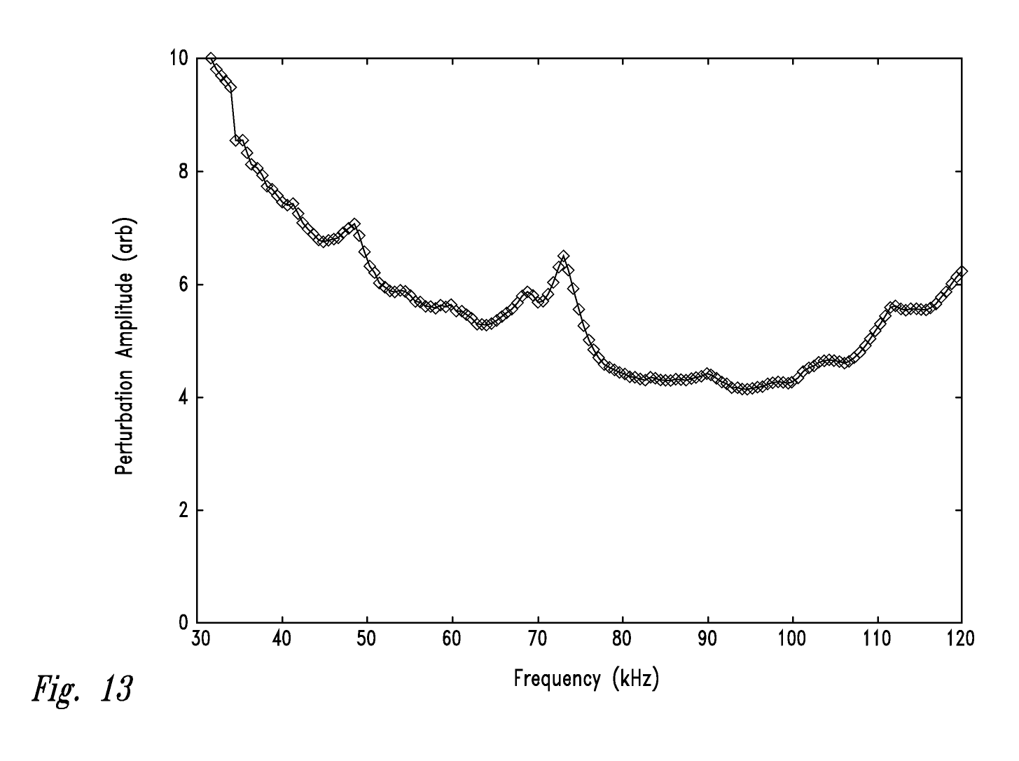

In contrast, a graph of performance of an implementation of the enhanced droplet flow cytometer system 100 is shown in FIG. 13 to have appreciable response at substantially all frequencies depicted including 40 kHz through at least 120 kHz. The relatively flat response curve shown in FIG. 13 is of relative significance since the enhanced system 100 demonstrates appreciable insensitivity to drift in driving frequency of the transverse oscillator 114 so the performance can be maintained at a consistently high level.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A system comprising:
a sheath tubing to contain sheath fluid;
a sample tubing to contain sample fluid, the sample tubing having an end;
a nozzle tubing having an interior, a longitude, and an end, the nozzle tubing coupled to the sheath tubing to receive sheath fluid, a portion of the sample tubing positioned in the interior of the nozzle tubing with the end of the sample tubing located in the interior of the nozzle tubing to inject sample fluid into the sheath fluid;
an oscillator externally coupled to the nozzle tubing, the oscillator configured to impart vibrational force substantially transverse to the longitude of the nozzle tubing; and
a nozzle coupled to the end of the nozzle tubing to exhaust a stream of the sample fluid and the sheath fluid, the stream having perturbation from the vibrational force sufficient to cause separation of portions of the stream into droplets.

2. The system of claim wherein the nozzle includes an orifice and at least a portion of the nozzle is shaped with cross-sectional area decreasing linearly as distance from the orifice decreases.

3. The system of claim 1 wherein the nozzle is removably coupled to the nozzle tubing at a location, the nozzle and the nozzle tubing having substantially the same inner diameter adjacent the location.

4. The system of claim 1 wherein the oscillator is a piezoelectric oscillator.

5. The system of claim 1 wherein the oscillator is substantially of cylindrical shape.

6. A method comprising:
imparting vibrational force to a sheath fluid substantially transverse to the flow of the sheath fluid;
injecting a sample fluid into the sheath fluid;
exhausting the sheath fluid and the sample fluid from a nozzle as a stream; and
allowing perturbations imparted to the sheath fluid by the vibrational force to separate portions of the stream into droplets.
